(19) United States
(12) Patent Application Publication
(10) Pub. No.: US 2026/0002611 A1
(43) Pub. Date: Jan. 1, 2026

(54) Support Arm For Wheel Balancer Air Inflation Hose

(71) Applicant: Hunter Engineering Company, Bridgeton, MO (US)

(72) Inventor: Nathan D. Palmer, Kirkwood, MO (US)

(21) Appl. No.: 19/248,196

(22) Filed: Jun. 24, 2025

Related U.S. Application Data
(60) Provisional application No. 63/664,939, filed on Jun. 27, 2024.

(51) Int. Cl. F16L 3/202; F16F 15/36; F16L 3/08

(52) U.S. Cl. CPC F16L 3/202; F16F 15/366; F16L 3/08

(57) ABSTRACT

A wheel balancing system having an air supply system including a retractable air hose carried within a pivoting support arm adjacent to a pivoting hood assembly for partially enclosing a wheel assembly mounted to a rotationally driven spindle. The retractable air hose couples a source of pressurized air to an air chuck configured for attachment to a wheel assembly inflation valve. A retraction mechanism contained within the pivoting support arm enables the air chuck and air hose to be drawn from the pivoting support arm during use, and to be automatically retracted to a stowed positioned within the support arm when not in use.

### CROSS-REFERENCE TO RELATED APPLICATIONS

The present application is related to, and claims priority from, U.S. provisional patent application Ser. No. 63/664,939 filed on Jun. 27, 2024, and which is herein incorporated by reference.

### STATEMENT REGARDING FEDERALLY SPONSORED RESEARCH

Not Applicable.

### BACKGROUND OF THE INVENTION

The present invention is related to vehicle wheel balancing machines configured to support a wheel rim and tire assembly on a rotating spindle for imbalance measurement, and in particular to a vehicle wheel balancing system including an air inflation hose located within a supporting armature in proximity to the wheel assembly.

When balancing a wheel assembly, an operator may need to adjust the inflation pressure of the tire to a specified value, either by deflating or inflating the tire as needed. In some cases, it is necessary to inflate or deflate the tire at a location separate from the wheel balancing system, which requires the additional steps of removing the wheel assembly from the balancer's spindle, adjusting the inflation pressure, and returning the wheel assembly to the spindle. An improvement in wheel balancing machines provides an air inflation hose at the wheel balancer, typically located on the front face where it can be easily accessed by an operator. A hanger or support on the front face of the wheel balancer provides a storage location for the loosely hanging air hose and an associated air chuck. However, it has been observed that a hanging air hose on the front face of a wheel balancer can interfere with an operator's movements, and risks entanglement with the wheel assembly during rotation of the spindle if not properly stowed when not in use. During use, an air hose located on the front face of the wheel balancer must be extended around the outside of a wheel assembly mounted to the spindle to reach an inflation valve. The length of the air hose limits the diameter of tire around which the air hose traverses to reach an inflation valve. If a wheel size prevents the air hose from reaching the inflation valve, the wheel assembly must still be removed from the spindle prior to inflation, resulting in lost time.

Accordingly, it would be beneficial to provide a wheel balancer with an air hose and air chuck in close proximity to an outer face of a spindle-mounted wheel assembly in order to accommodate a wide range of wheel sizes, and to reduce or eliminate entanglement risks when not in use.

### BRIEF SUMMARY OF THE INVENTION

The present application sets forth a wheel balancing system having an air supply system which includes a length of retractable air hose carried within a pivoting support arm. The support arm is mounted adjacent to a pivoting hood assembly which partially encloses a wheel assembly undergoing imbalance measurement when mounted to a rotationally driven spindle. The retractable air hose couples a source of pressurized air to an air chuck configured for attachment to an inflation valve of the wheel assembly. A retraction mechanism contained within the pivoting support arm enables the air chuck and air hose to be drawn from the pivoting support arm during use, and to be automatically retracted to a stowed positioned within the support arm when not needed. In the stowed position, the air chuck and air hose are retained within the support arm, clear of the wheel assembly and rotating components of the wheel balancing system. In a lowered rotational position, the pivoting support arm positions the air chuck and air hose in close proximity to the outboard face of the wheel assembly and within reach of the wheel assembly inflation valve. Enabling the support arm and the hood assembly to independently pivot upward to an elevated position provides clearance for mounting or demounting the wheel assembly from the rotationally driven spindle.

In a further embodiment of the present disclosure, the air chuck coupled to the air hose is configured for automatic release from the inflation valve of the wheel assembly. During inflation of a tire, a tire inflation pressure is monitored by a control system which is configured to automatically release the air chuck from the inflation valve when the tire inflation pressure reaches a predetermined level. Once released from the inflation valve, the air hose and air chuck are automatically retracted into the pivoting support arm, enabling imbalance measurement procedures to begin automatically without requiring further operator intervention.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is perspective view of a wheel balancing system incorporating an air hose support arm of the present disclosure with the air hose support arm in an operative position adjacent to a lowered protective hood assembly;

FIG. 2 is a side view of the balancer of FIG. 1;

FIG. 3 is a perspective view of the balancer of FIG. 1, with the protective hood in a raised position, and the air hose support arm in the lowered operative position;

FIG. 4 is a perspective view similar to FIG. 3, with the air hose support arm in a raised position adjacent to the raised protective hood assembly;

FIG. 5 is a perspective side view of the air hose support arm assembly;

FIG. 6 is a top plan view of the air hose support assembly of FIG. 5;

FIG. 7 is a sectional view of the air hose support assembly of FIG. 5;

FIG. 8 is an enlarged view of the rear portion of FIG. 7; and

FIG. 9 is a section view of the air hose support assembly, with the air chuck and air hose in an extended position.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

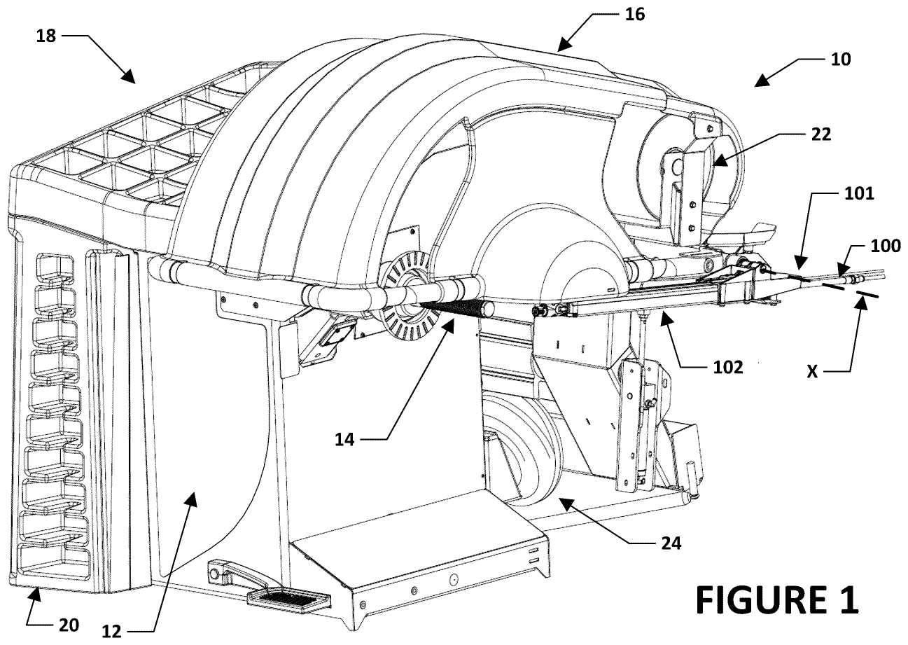

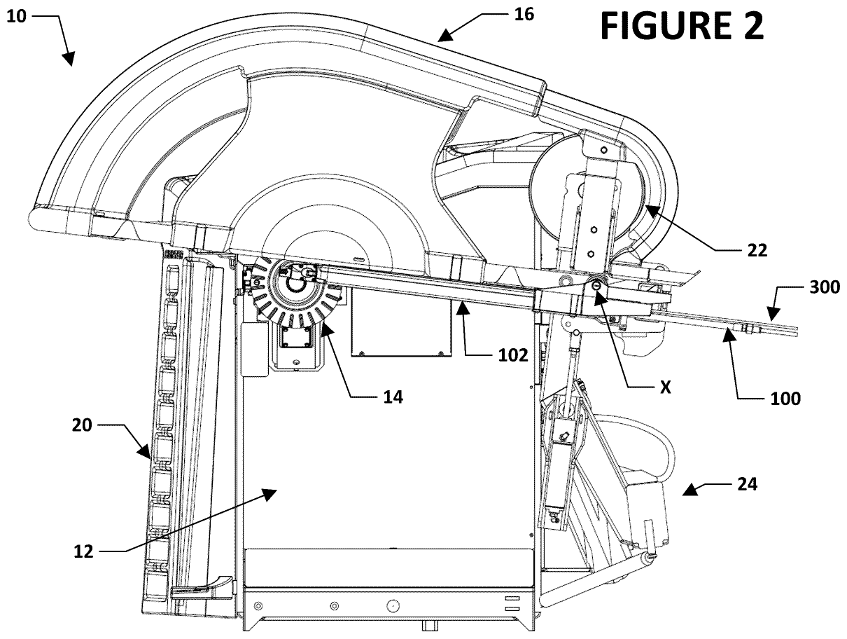

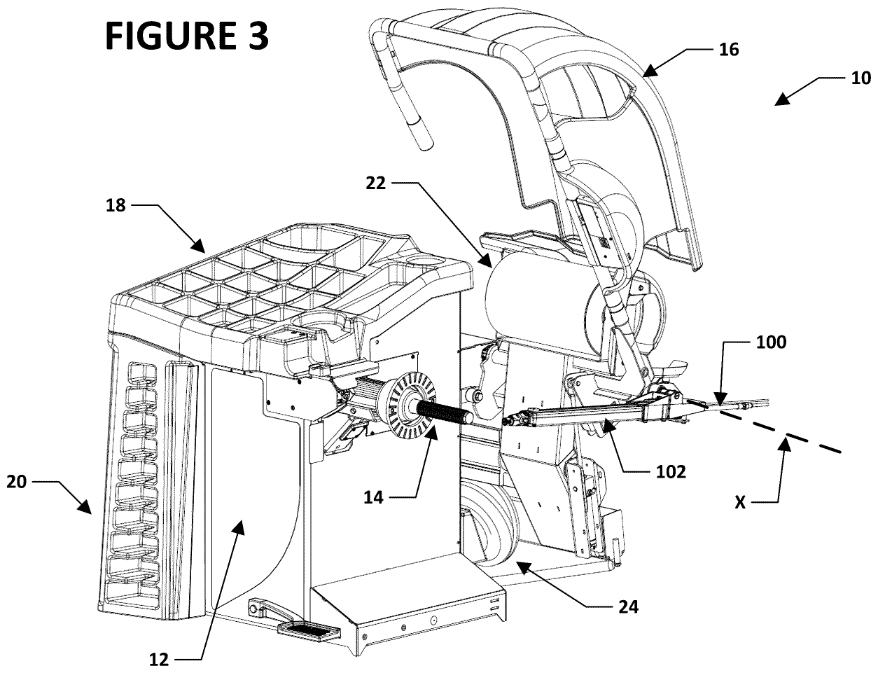

Turning to the figures, a typical wheel balancing system 10 is shown in FIGS. 1-4 comprising a tub or body 12, a rotationally driven spindle 14 extending horizontally from one side of the tub or body, and a pivoting hood enclosure 16 positioned to partially enclose a wheel assembly secured to the spindle 14 during an imbalance measurement procedure. A weight storage tray 18 and collet storage rack 20 are further carried by the tub or body 12. An optional load roller 22 and associated actuation mechanism 24 for applying a radial load to a spindle-mounted wheel assembly may be further secured to the tub or body 12. Within the tub or body 12, various structures and sensors (not shown) are positioned to measure imbalance forces exerted by the spindle-mounted wheel assembly during imbalance measurement procedures. Additionally contained within the tub or body 12 are a drive motor for the spindle 14, and a control system for operating the wheel balancing system 10 and communicating with an operator via suitable display interfaces. Those of ordinary skill in the art will recognize that wheel balancing systems may vary from the appearance shown in the figures and from the aforementioned typical features without departing from the scope of the present disclosure.

To facilitate inflation of a tire on a wheel assembly secured to the spindle 14, the wheel balancing system 10 further includes an air delivery system positioned outboard from the spindle 14, including an air hose 100 coupled at a distal end to a source of pressurized air such as a shop air supply, a tank of pressurized air, or an air pump. In one embodiment, the air hose 100 is routed longitudinally into a hollow support arm 102 through an opening at a rear end 101. As shown, the support arm 102 is preferably mounted adjacent to the pivoting hood enclosure 16, and is configured for independent pivoting movement about an axis which is coaxial with, or parallel to, the pivot axis X of the hood enclosure 16. Independent pivoting movement of the hood enclosure 16 and support arm 102 enables an operator to pivot the hood 16 upward to expose the wheel assembly during tire inflation, and to separately pivot the support arm 102 upward to provide clearance when the wheel assembly is to be secured to, or removed from, the spindle 14. It is envisioned that the air delivery system of the present disclosure may alternatively be affixed to, and used with, a wheel balancer system 10 which does not include a pivoting hood enclosure 16, such as by direct pivoting attachment to the tub or body 12. Further, while the embodiment is shown and described within a hollow support arm 102, it will be recognized that the various components can be utilized with support arms of different configurations, and may be secured to the exterior surfaces of a solid support arm or a support framework without departing from the scope of the invention.

The proximal end of the air hose 100 is coupled to an air chuck 104 adapted for temporary attachment to a wheel assembly inflation valve. With the air hose 100 in a retracted position, the air chuck 104 seats within a receiver 106 having an axial bore at a forward end of the support arm 102. During use, the air chuck 104 is pulled from the receiver 106, drawing a length of air hose 100 through the axial bore of the support arm 102, enabling the air chuck 104 to be coupled to the inflation valve of a wheel assembly secured to the spindle 14. Once the air chuck is coupled to the inflation valve, a flow of pressurized air is delivered (or drawn) through the air hose 100 and air chuck 104 to alter an tire inflation pressure for the wheel assembly.

A hose carrier and return mechanism 200 carried by, or contained within, the support arm 102 limits the amount of air hose 100 which can be drawn through the support arm during use, and provides a biased retractive force to return the air chuck 104 to the receiver 106 when released from an inflation valve. In one embodiment the return mechanism includes a hose clamp body 202 secured to the air hose adjacent to the rear portion of the support arm 102 when the air chuck 104 is seated in the receiver 106. The hose clamp body as shown is configured for longitudinal sliding movement within a hollow interior of the support arm 102, such by direct sliding engagement with the interior surfaces 102a of the support arm, or by rolling engagement on a set of rollers 204 contacting an interior surface 102a. The number and placement of the rollers 204 (on the hose clamp body or on the support art 102) may be configured to reduce friction during movement of the air hose, and to achieve a preferred feel for the user.

As the air chuck 104 and air hose 100 are drawn from the receiver 106, the hose clamp body is longitudinally drawn along, or through the interior of, the support arm 102. When the hose clamp body 202 abuts an annular restriction formed by the receiver 106 at the forward end of the support arm 102, further forward movement of the air hose 100 and air chuck 104 are prevented, limiting the distance for withdrawal of the air chuck and air hose. The length of air hose 100 which can be displaced from the support arm 102 is limited by the travel distance for the hose clamp body 202 within the support arm, and hence by the length of the support arm itself. In an exemplary configuration the travel distance for the air hose and air chuck is limited to 18″ of displacement from the receiver 106, which has been found to accommodate a wide range of wheel assembly configurations when mounted to the spindle 14 for a wheel balancing system 10 configured as shown in FIGS. 1-4. In an alternate configuration, the hose clamp body 202 is not included, and the length of air hose 100 which can be withdrawn from the support arm is limited by other means, such as by direct attachment to a bias element described below.

A bias element 206 is operatively engaged with the air hose to provide a retractive force to return the hose clamp body 202, and correspondingly the air hose 100 and air chuck 104 to the retracted position when not in use. In the retracted position, the air chuck 104 and air hose 100 are clear of the wheel assembly and rotating components of the wheel balancing system 10. In one embodiment, the bias element 206 is an extension spring or elastomeric member coupled between the hose clamp body 202 and an attachment 208 adjacent to the rear of the support arm. Those of ordinary skill in the art will recognize that the bias element 206 need not be limited to an extension spring or elastomeric member, and may include, but is not limited to, a compression spring positioned to compress upon withdrawal of the air chuck and hose, an pneumatic- or hydraulic-cylinder, or an external weight secured directly to a hanging distal portion of the air hose. In yet another configuration, the air hose 100 may be routed to an automatically retracting hose reel located rearward of the support arm which acts as a bias element 206.

In one embodiment the presence of the hose clamp body 202 adjacent to the rear portion of the support arm is detected via a suitable sensor, such as a Hall effect sensor triggered by a magnet secured to the hose clamp body. Output from the sensor is communicated to the control system, and may be utilized to determine when the air chuck and hose have been drawn from the retracted position for use, or when the air chuck and hose have returned to the retracted position and are clear of the wheel assembly and rotating components of the wheel balancing system. Those of ordinary skill in the art will recognize that in an alternative configuration, the sensor may be placed within the receiver 106, and a magnet secured to the air chuck 104 to achieve the same output for communication to the control system.

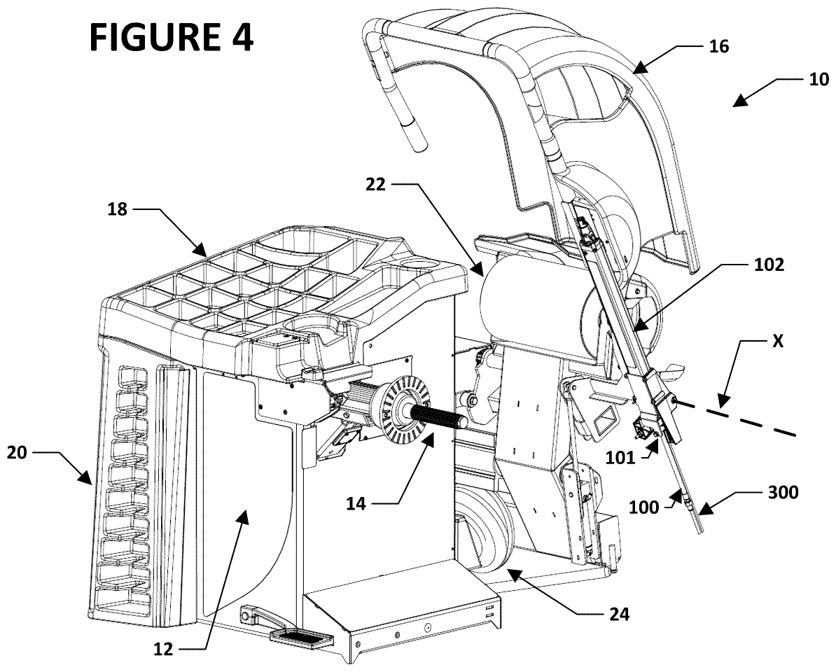

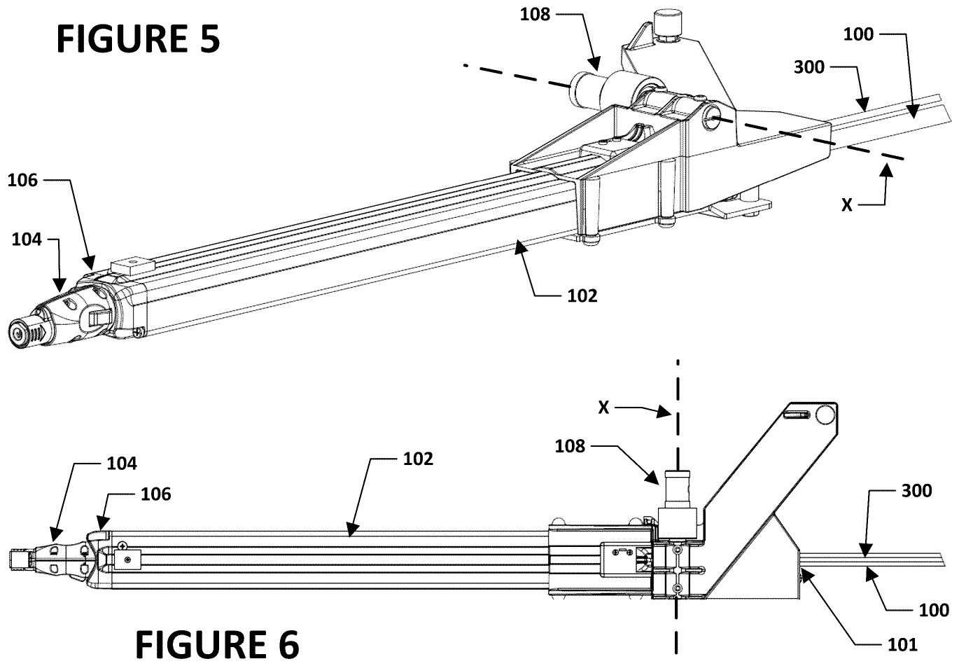

Preferably, the support arm 102 is secured to the balancer tub or body 12 via a pivoting connection 108 adjacent a rear portion of the support arm. In one embodiment, the pivoting connection is a pivot pin or shaft, which is coupled either coaxial with, or parallel to, a pivoting bracket or arm supporting the balancer hood 16, such that the support arm 102 is located axially outward from the hood 16. In a lowered position, as seen in FIG. 1-3 the support arm 102 positions the air chuck 104 and air hose 100 outboard of, and in close proximity to, the spindle 14 on which a wheel assembly is mounted. Independently pivoting the support arm 102 to a raised or elevated position when the hood 16 is already raised, such as shown in FIG. 4 provides clearance for mounting or demounting the wheel assembly from the spindle 14.

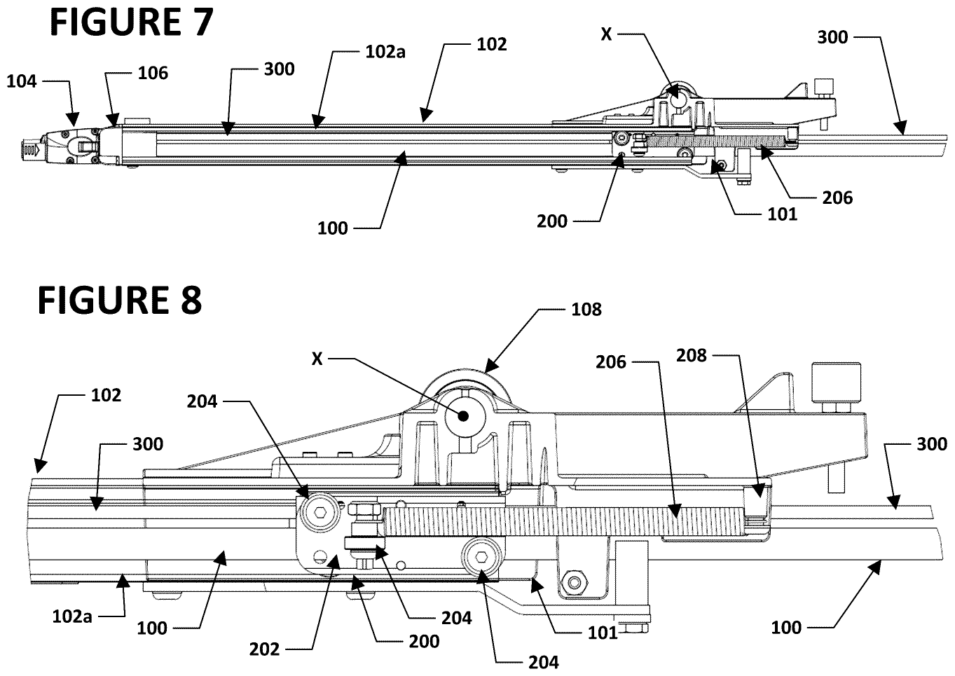

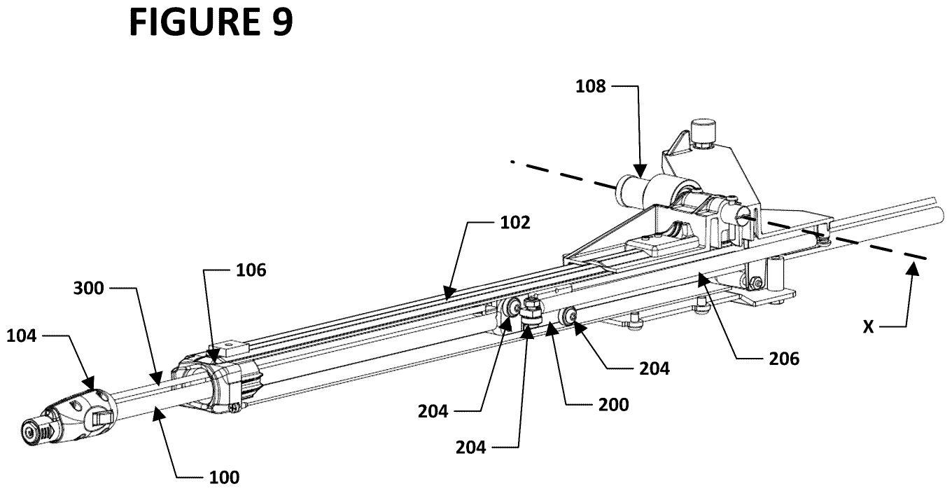

In a further embodiment of the present disclosure, the air chuck 104 coupled to the air hose 100 is configured for controlled release from a wheel assembly inflation valve, such as by means of a release mechanism actuated via a control cable 300 shown in FIGS. 7-9. An exemplary air chuck configured for controlled and/or automatic release is shown and described in PCT international patent application serial No. PCT/US2024/050223, which is herein incorporated by reference.

During inflation of a tire on a wheel assembly secured to the spindle 14 of the balancing system 10, a control system is configured to monitor the tire inflation pressure via the air pressure within the air hose 100, and to automatically release the air chuck 104 from the inflation valve when the tire inflation pressure reaches a predetermined level. Once released from the inflation valve, the air hose 100 and air chuck 104 retracts into the receiver 106 of the pivoting support arm 102, enabling imbalance measurement procedures, including rotation of the wheel assembly on the spindle 14, to begin automatically. Automatic release and retraction of the air chuck and air hose eliminates the need for an operator to standby and await completion of an inflation procedure before manually disconnecting the air chuck and initiating an imbalance measurement procedure. Exemplary wheel imbalance measurement processes utilizing controlled and/or automatic release of the air chuck from the inflation valve of the wheel assembly are set forth and described in co-pending U.S. provisional patent application Ser. No. 63/595,195 which is herein incorporated by reference.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. An air hose support for a wheel balancing system having a body supporting a rotationally driven spindle configured to receive a wheel assembly, and a hood assembly coupled to the body by a support arm for pivoting between a raised position away from the spindle and a lowered position partially enclosing the spindle and a supported wheel assembly, comprising:
a support arm having a pivot at a rear end coupled to the hood support arm for rotation between a raised position and a generally horizontal lowered position parallel to said supported wheel assembly, said support arm having a receiver with an axial bore at a forward end in proximity to said rotationally driven spindle;
an air chuck configured to seat within said receiver, said air chuck coupled to a first end of an air hose traversing said axial bore and longitudinally along said support arm to a supply of pressurized air at a second end of said air hose;
a hose clamp body carried by said support arm, said hose clamp body affixed to a portion of said air hose which is disposed adjacent to a rear end of said support arm when said air chuck is seated within said receiver;
wherein said hose clamp body is configured for limited longitudinal movement along said support arm between said rear end and said receiver; and
a bias element operatively engaged with said air hose and/or said hose clamp body exerting a return bias force on said air hose during displacement of said air chuck from said receiver.

2. The air hose support of claim 1 wherein said air chuck includes an automatic release mechanism configured to release said air chuck from engagement with an inflation valve.

3. The air hose support of claim 1 wherein said support arm is configured to pivot about a coupling between said lowered position in which said forward end is in proximity to said rotationally driven spindle, and said raised position displaced from said rotationally driven spindle.

4. The air hose support of claim 3 wherein said support arm is configured to pivot independent of said hood.

5. The air hose support of claim 1 wherein longitudinal displacement of said hose clamp body within said support arm limits a distance which said air chuck and air hose can be drawn away from said receiver during use.

6. The air hose support of claim 1 wherein said hose clamp body includes a plurality of rollers, each of said plurality of rollers engaged with an inner surface of said hollow support arm.

7. The air hose support of claim 1 wherein said hose clamp body includes a set of sliding surfaces, said sliding surfaces engaged with a surface of said support arm.

8. The air hose support of claim 1 wherein said bias member is a spring.

9. The air hose support of claim 1 wherein said bias element is coupled between said hose clamp body and an attachment at said rear end of said support arm.

10. The air hose support of claim 1 wherein said bias element is at least one of a compression spring, an extension spring, an elastomeric element, a pneumatic cylinder, a hydraulic cylinder, or a weight element.

11. A wheel balancer air supply system, comprising:
a support arm having a hollow longitudinal body enclosed at a forward end by an air chuck receiver, and having an opening at a rearward end;
an air chuck configured to seat within said receiver, said air chuck coupled to a first end of an air hose entering said support arm through said opening, traversing the hollow longitudinal body, and passing through an axial bore in said receiver, said air hose having a second end coupled to a source of pressurized air;
wherein said air hose is configured for longitudinal movement within said hollow longitudinal body between said opening and said receiver; and
a bias member operatively coupled to said air hose, said bias member exerting a rearward bias force on said air hose during said longitudinal movement of said air hose within said hollow longitudinal body.

12. The wheel balancer air supply system of claim 11 further including a hose clamp body contained within said hollow longitudinal body, said hose clamp body affixed to said air hose adjacent to said opening when said air chuck is seated within said receiver; and
wherein said hose clamp body configured for longitudinal movement within said hollow longitudinal body between said opening and said receiver.

13. The wheel balancer air supply system of claim 12 wherein said bias member is operatively coupled to said hose clamp body.

14. The wheel balancer air supply system of claim 11 further including a coupling adjacent said rearward end of said hollow longitudinal body, said coupling configured for rotational movement about an axis transverse to a longitudinal axis of said support arm.

15. A method for operating a wheel balancer system configured with a pivoting air hose support in proximity to a driven spindle for supporting a wheel assembly, the air hose support having a support arm carrying an air hose to an air chuck seated in a receiver at a forward end of the support arm, comprising
raising said support arm by pivoting about a rear pivot axis;
securing a wheel assembly consisting of a wheel rim and tire to said rotationally driven spindle;
lowering said support arm by pivoting about said rear pivot axis;
drawing said air chuck and air hose from said receiver;
coupling said air chuck to an inflation valve of said wheel assembly;
initiating a flow of pressurized air from said supply to said air chuck through said air hose, said flow of pressurized air entering said inflation valve to pressurize said tire;
terminating said flow of pressurized air upon achieving a selected pressure within said tire;
releasing said air chuck from said inflation valve;
retracting said air hose into said support arm to seat said air chuck in said receiver; and
initiating an imbalance measurement procedure for said wheel assembly.

16. The method of claim 15 further including raising said hood assembly by pivoting upward about a rear pivot axis prior to securing said wheel assembly to said rotationally driven spindle; and
lowering said hood assembly by pivoting downward about said rear pivot axis prior to initiating said flow of pressurized air.

17. The method of claim 15 wherein said steps of terminating, releasing, retracting, and initiating occur automatically.

18. An air hose support for a wheel balancing system having a body supporting a rotationally driven spindle configured to receive a wheel assembly, comprising:
a hollow support arm having a receiver with an axial bore at a forward end, and a coupling adjacent a rear end pivotally secured relative to the body for rotation between a lowered position wherein said receiver is in proximity to said rotationally driven spindle, and a raised position wherein said receiver is displaced rearward and upward from said rotationally driven spindle;
an air chuck configured to seat within said receiver, said air chuck coupled to a first end of an air hose traversing said axial bore and longitudinally through said hollow support arm to a supply of pressurized air at a second end of said air hose;
a hose clamp body contained within said hollow support arm, said hose clamp body affixed to a portion of said air hose which is disposed adjacent to a rear end of said hollow support arm when said air chuck is seated within said receiver;
wherein said hose clamp body is configured for longitudinal movement within said hollow support arm between said rear end and said receiver; and
a bias member coupled between said hose clamp body and an attachment pin at said rear end of said hollow support arm, said bias member exerting a return bias force on said hose clamp body during longitudinal displacement within said hollow support arm.

19. The air hose support of claim 18, wherein said balancing system further includes a hood assembly pivotally coupled to the body by a support arm for partially enclosing the spindle and wheel assembly in a lowered position and for displacement away from said spindle in a raised position;
wherein said coupling is secured for independent rotation coaxial to said support arm; and
wherein said hollow support arm is aligned parallel to said hood in a lowered position.
